(19) United States
(12) Patent Application Publication
(10) Pub. No.: US 2025/0296174 A1
(43) Pub. Date: Sep. 25, 2025

(54) LASER WELDING DEVICE

(71) Applicant: GENII IDEAS Co., Ltd., HSINCHU CITY (TW)

(72) Inventors: KUO CHIANG TSENG, HSINCHU CITY (TW); CHIH YU WENG, HSINCHU CITY (TW); PEI YU WANG, HSINCHU CITY (TW); TZU WEN SUNG, HSINCHU CITY (TW); FENG CHI WEI, HUALIEN COUNTY (TW)

(21) Appl. No.: 18/662,411

(22) Filed: May 13, 2024

(30) Foreign Application Priority Data
Mar. 20, 2024 (TW) 113202784

(51) Int. Cl. B23K 26/282; B23K 26/06; B23K 37/02

(52) U.S. Cl. CPC B23K 26/282; B23K 26/0643; B23K 37/0247

(57) ABSTRACT

A laser welding device includes a base having two support members to fix a first workpiece and a second workpiece. A positioning assembly positioned above the base includes a fixed clamp and two connecting pieces which are respectively located on both sides of the fixed clamp. A laser device and a reflection assembly are respectively attached to the fixed clamp. The fixed clamp is connected to a support assembly. The reflection assembly includes a reflection mirror corresponding to the laser device. A drive assembly is attached to the support assembly of the laser device. A linkage rotation assembly is connected between the drive assembly and the connecting pieces of the positioning assembly. The positioning assembly gathers two respective end faces of the first and second workpieces to proceed end-to-end welding operation by the laser device, the reflection assembly, and the linkage rotation assembly to the two respective end faces.

### FIELD OF THE INVENTION

The present invention relates to a laser welding device, particularly to a simplified structure of a laser welding device.

### BACKGROUND OF THE INVENTION

A laser welding machine 9, as shown in FIG. 7, utilizes the energy of the laser for welding operations. The laser welding machine 9 is disclosed in Taiwan Invention Patent No. TW202346015A, “Automated Assisted Welding Equipment.” The laser welding machine 9 employs a laser generator to produce a beam of light, which is then expanded, reflected, and focused before being radiated onto the surface of a workpiece 91. The surface heat causes the workpiece to melt through heat conduction, forming a specific molten pool, thereby achieving laser welding of the workpiece 91.

However, the laser welding machine 9 uses a connecting rod assembly 92 to connect the machine. Through the vertical and horizontal movement of the connecting rod assembly 92, three-dimensional position and angle changes are achieved. The end of the connecting rod assembly 92 is connected to a laser gun 93. During displacement, the connecting rod assembly 92 easily affects the laser gun 93, causing instability during welding operations, resulting in inaccurate or offset welding. Therefore, there is a need for improvement.

In view of the above problems with the conventional laser welding machine, the present invention provides a laser welding device to improve welding quality, and the secondary objective is to reduce costs.

### SUMMARY OF THE INVENTION

The present invention relates to a laser welding device and comprises a base having two support members which fix a first workpiece and a second workpiece to be processed. A positioning assembly is positioned above the base and includes a fixed clamp and two connecting pieces. The two connecting pieces are respectively connected to both sides of the fixed clamp. A laser device is attached to the fixed clamp, and the fixed clamp is connected to a support assembly. A reflection assembly is attached to the fixed clamp and includes a reflection mirror corresponding to the laser device. A drive assembly is attached to the support assembly of the laser device. A linkage rotation assembly has one of two ends thereof connected to the drive assembly via a motor, and another one of the two ends of the linkage rotation assembly is connected to the connecting pieces of the positioning assembly. The positioning assembly gathers two respective end faces of the first workpiece and the second workpiece to be processed so as to proceed end-to-end welding operation by the laser device, the reflection assembly, and the linkage rotation assembly.

Preferably, the two support members secure the first workpiece and the second workpiece to maintain positions of the first and second workpieces.

Preferably, the fixed clamp of the positioning assembly radially extends with a first fixed block and a second fixed block. A perforation is provided between the first fixed block and the second fixed block.

Preferably, the reflection assembly is attached to the first fixed block. The laser device is attached to the second fixed block. The laser device corresponds to the reflection mirror of the reflection assembly.

Preferably, the laser device generates a laser beam directed to the reflection mirror of the reflection assembly, and the laser beam is deflected at an angle and passes through the perforation.

Preferably, the laser device further comprises four guide tubes which penetrate through four fixing holes in the fixed clamp to position the laser device.

Preferably, the fixed clamp of the positioning assembly is pivotally connected to two movable clamps, and the two movable clamps are respectively connected to the two connecting pieces.

Preferably, the linkage rotation assembly further comprises a first gear and a second gear which is smaller than the first gear in diameter. The first gear is attached to an outer side of the second connecting piece of the positioning assembly. The second gear is attached to the motor of the drive assembly, and is engaged with the large gear.

Preferably, the positioning assembly further comprises two fixed shaft components and a cover. The two fixed shaft components are respectively connected to the two connecting pieces. The cover covers the linkage rotation assembly.

Preferably, the linkage rotation assembly drives the fixed clamp, the laser device, and the reflection assembly to rotate about a central axis of the large gear. The present invention achieves the following effects:
1. By driving the first gear through the second gear of the drive assembly, together with the linkage rotation assembly, the laser device and the reflection assembly rotate about the central axis. Meanwhile, the first workpiece, the second workpiece, the two connecting pieces, and the two fixed shaft components remain stationary. This allows the laser device to rotate steadily throughout the welding operation, thereby improving processing accuracy.
2. By combining the laser device with the linkage rotation assembly using simple gear engagement, without the need for complex linkage structures, the laser device rotates about the central axis. This eliminates the requirement for complex linkage structures, thus reducing the manufacturing cost of the laser welding device.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view of the laser welding device of the present invention;

FIG. 2 is an exploded view of the laser welding device of the present invention;

FIG. 3 is a cross sectional view of the laser welding device of the present invention;

FIG. 4 illustrates that the laser device being activated, causing the laser beam to be reflected by the reflection mirror;

FIG. 5 is a cross sectional view, taken along line X-X of FIG. 4;

FIG. 6 shows that the linkage rotation assembly drives the laser device to rotate about the central axis for welding operations, and

FIG. 7 shows a conventional laser welding machine.

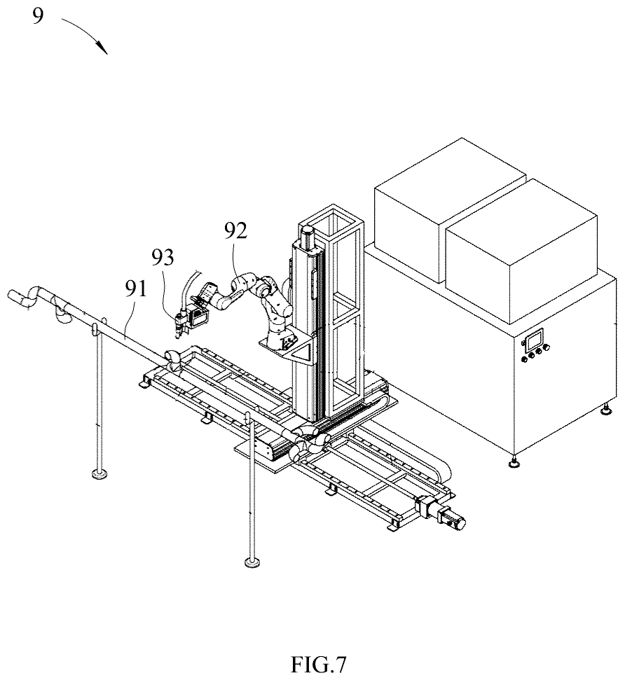

### DETAILED DESCRIPTION OF THE PREFERRED EMBODIMENT

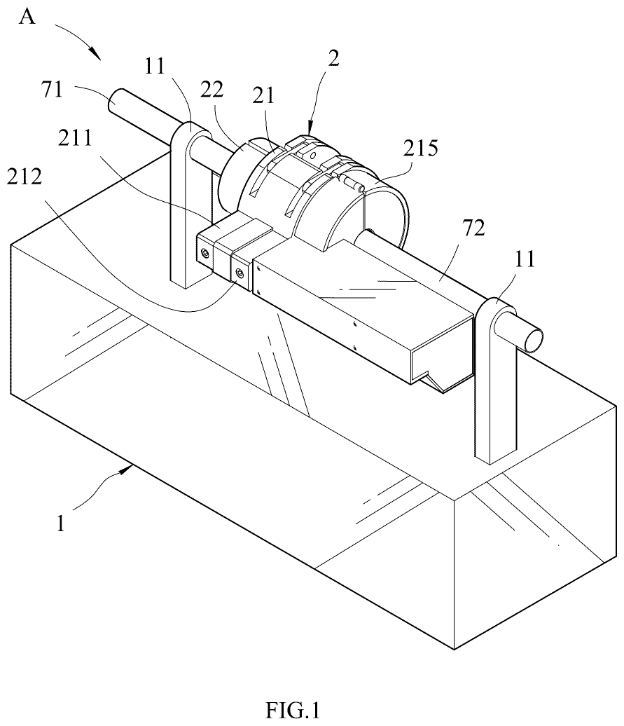

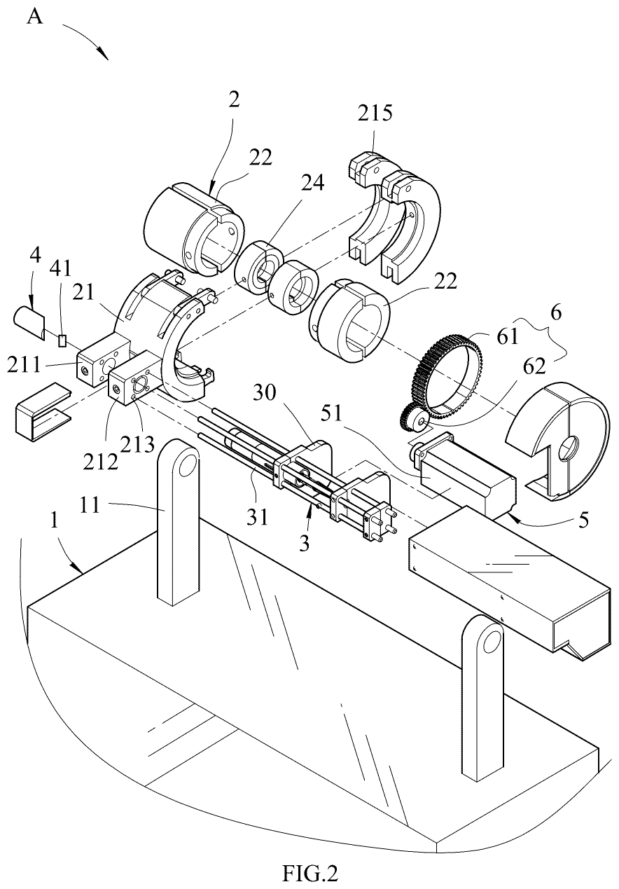

Referring to FIGS. 1 and 2, the laser welding device “A” of the present invention is used for end-to-end welding operations on a first workpiece 71 and a second workpiece 72. the laser welding device “A” of the present invention comprises a base 1, a positioning assembly 2, a laser device 3, a reflection assembly 4, a drive assembly 5, and a linkage rotation assembly 6.

The base 1, as shown in FIGS. 1 and 2, is in contact with the ground for support. Two support members 11 are attached to the base 1 and are used to fix the first workpiece 71 and the second workpiece 72 in position to prevent bending due to gravity and ensure the quality of welding operations.

The positioning assembly 2, as shown in FIGS. 1 and 2, includes a fixed clamp 21, two connecting pieces 22, and two fixed shaft components 24. The two connecting pieces 22 are respectively connected to both sides of the fixed clamp 21. The two support members 11 are positioned above the base 1 and are in contact with the first workpiece 71, ensuring its fixed position.

Furthermore, as shown in FIGS. 1 to 3, the fixed clamp 21 radially extends with a first fixed block 211 and a second fixed block 212, between which there is a perforation 214. The reflection assembly 4 is attached to the first fixed block 211, and the laser device 3 is attached to the second fixed block 212. Additionally, the fixed clamp 21 is pivotally connected to two movable clamps 215, and the two movable clamps 215 are respectively connected to the two connecting pieces 22 for fixation. It is noted that the tight integration of the fixed clamp 21 and the movable clamps 215 on the first workpiece 71 and the second workpiece 72 ensures stability without wobbling.

The laser device 3, as shown in FIGS. 1 and 2, is attached to the fixed clamp 21. The laser device 3 includes four guide tubes 31, which penetrate through four fixing holes 213 provided in the fixed clamp 21 to position the laser device 3. The laser device 3 generates a laser beam 32 directed to the reflection mirror 41 of the reflection assembly 4, allowing the laser beam 32 to pass through the perforation 214 of the fixed clamp 21 after being deflected by the reflection mirror 41.

The reflection assembly 4, as shown in FIGS. 1 and 2, is attached to the fixed clamp 21 and includes a reflection mirror 41 corresponding to the laser device 3.

The drive assembly 5, as shown in FIGS. 1 and 2, is attached to the laser device 3 and includes a motor 51, which is attached to a support assembly 30 of the laser device 3.

The linkage rotation assembly 6, as shown in FIGS. 1 and 2, includes a first gear 61 and a second gear 62 which is smaller than the first gear in diameter. The first gear 61 is attached to the outer side of the second connecting piece 22 of the positioning assembly 2, while the second gear 62 is attached to a shaft of the motor 51 of the drive assembly 5. The second gear 62 engages with the first gear 61. The linkage rotation assembly 6 drives the fixed clamp 21, the movable clamps 215, the laser device 3, and the reflection assembly 4 to rotate about the central axis “Z” of the first gear 61 at an angle or a circle.

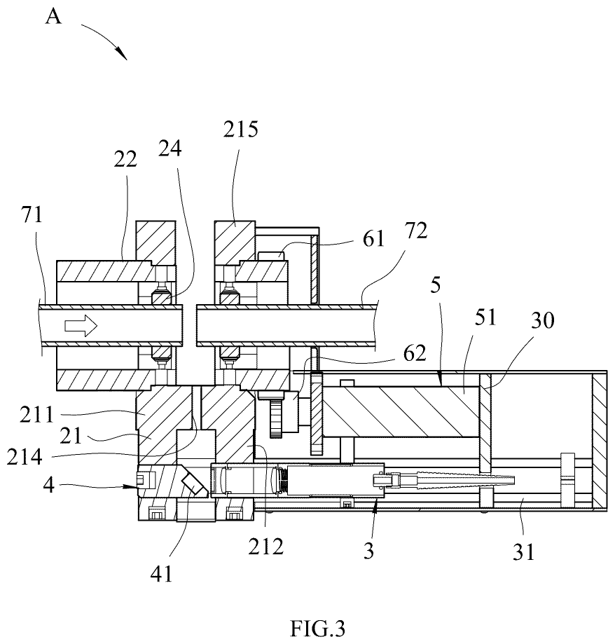

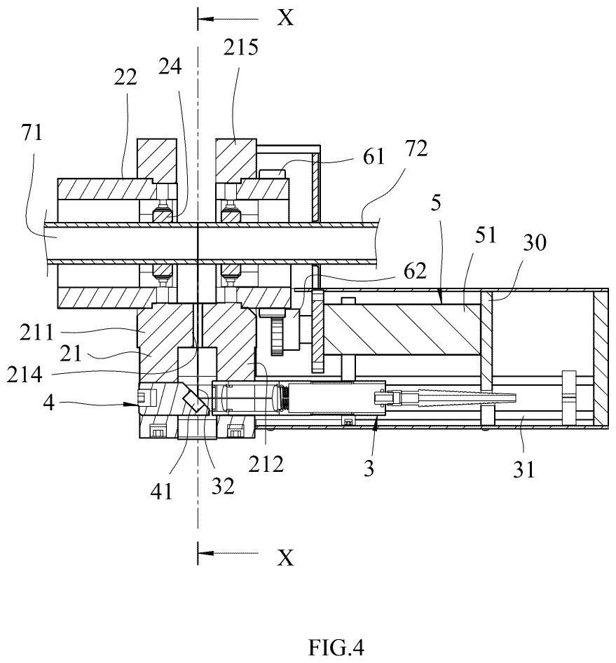

Therefore, the laser welding device “A” provides a better solution. As shown in FIGS. 3 and 4, the user mounts the first workpiece 71 and the second workpiece 72 on the fixed shaft components 24 of the positioning assembly 2 and secures them in place using the movable clamps 215 on the fixed clamp 21. The end face of the first workpiece 71 is brought into contact with the end face of the second workpiece 72 and pre-welded at some points. The operator activates the laser device 3 to project the laser beam 32 onto the reflection mirror 41 of the reflection assembly 4. The laser beam 32 is reflected and rotated by 90 degrees by the reflection mirror 41, passing through the perforation 214 of the fixed clamp 21 to weld the contact surface of the end faces of the first workpiece 71 and the second workpiece 72.

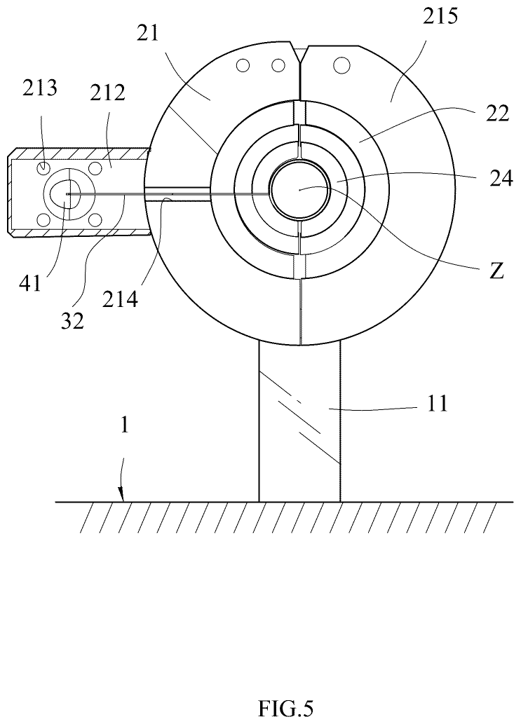

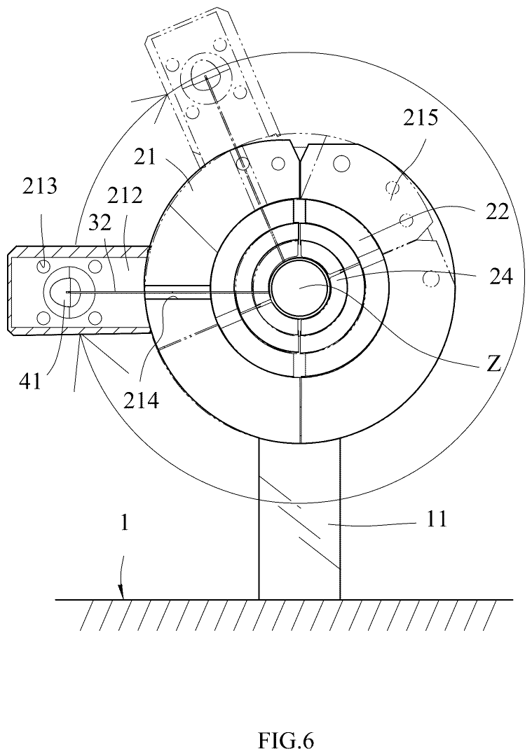

Furthermore, as shown in FIGS. 4 to 6, activating the motor 51 of the drive assembly 5 drives the second gear 62 to rotate. The second gear 62 engages with the first gear 61, forcing the fixed clamp 21, the movable clamps 215, the laser device 3, the reflection assembly 4, and the drive assembly 5 to rotate about the central axis “Z” of the first gear 61 to change the welding angle. Meanwhile, the two connecting pieces 22, the two fixed shaft components 24, the first gear 61, the first workpiece 71, and the second workpiece 72 remain stationary. After welding is completed, the laser device 3 stops operation, and the next batch of workpieces is positioned for welding by again activating the laser device 3 and driving the motor 51 to rotate in the opposite direction.

While we have shown and described the embodiment in accordance with the present invention, it should be clear to those skilled in the art that further embodiments may be made without departing from the scope of the present invention.

What is claimed is:

1. A laser welding device comprising:
a base having two support members, the two support members adapted to fix a first workpiece and a second workpiece to be processed;
a positioning assembly positioned above the base and including a fixed clamp and two connecting pieces, the two connecting pieces respectively connected to both sides of the fixed clamp;
a laser device attached to the fixed clamp, the fixed clamp connected to a support assembly;
a reflection assembly attached to the fixed clamp, the reflection assembly including a reflection mirror corresponding to the laser device;
a drive assembly attached to the support assembly of the laser device, and
a linkage rotation assembly having one of two ends of the linkage rotation assembly connected to the drive assembly via a motor, and another one of the two ends connected to the connecting pieces of the positioning assembly, the positioning assembly adapted to position two respective end faces of the first workpiece and the second workpiece so as to proceed end-to-end welding operation by the laser device, the reflection assembly, and the linkage rotation assembly.

2. The laser welding device as claimed in claim 1, wherein the two support members are adapted to secure the first workpiece and the second workpiece to maintain positions of the first and second workpieces.

3. The laser welding device as claimed in claim 1, wherein the fixed clamp of the positioning assembly radially extends with a first fixed block and a second fixed block, a perforation is provided between the first fixed block and the second fixed block.

4. The laser welding device as claimed in claim 3, wherein the reflection assembly is attached to the first fixed block, the laser device is attached to the second fixed block, the laser device corresponds to the reflection mirror of the reflection assembly.

5. The laser welding device as claimed in claim 4, wherein the laser device generates a laser beam directed to the reflection mirror of the reflection assembly, the laser beam is deflected at an angle and passes through the perforation.

6. The laser welding device as claimed in claim 1, wherein the laser device further comprises four guide tubes, the four guide tubes penetrate through four fixing holes in the fixed clamp to position the laser device.

7. The laser welding device as claimed in claim 1, wherein the fixed clamp of the positioning assembly is pivotally connected to two movable clamps, and the two movable clamps are respectively connected to the two connecting pieces.

8. The laser welding device as claimed in claim 1, wherein the linkage rotation assembly comprises a first gear and a second gear which is smaller than the first gear in diameter, the first gear is attached to an outer side of the second connecting piece of the positioning assembly, the second gear is attached to the motor of the drive assembly, and is engaged with the large gear.

9. The laser welding device as claimed in claim 8, wherein the positioning assembly comprises two fixed shaft components and a cover, wherein the two fixed shaft components are respectively connected to the two connecting pieces, the cover covers the linkage rotation assembly.

10. The laser welding device as claimed in claim 9, wherein the linkage rotation assembly drives the fixed clamp, the laser device, and the reflection assembly to rotate about a central axis of the first gear.
